(19) United States
(12) Patent Application Publication
(10) Pub. No.: US 2024/0311173 A1
(43) Pub. Date: Sep. 19, 2024

(54) SCHEDULING METHOD, VIRTUAL MACHINE MONITOR, ELECTRONIC DEVICE AND STORAGE MEDIUM

(71) Applicant: Samsung Electronics Co., Ltd., Suwon-si (KR)

(72) Inventors: Yuehua DAI, Xi'An (CN); Daihuan ZHOU, Xi'An (CN); Mindong ZHAO, Xi'An (CN)

(73) Assignee: Samsung Electronics Co., Ltd., Suwon-si (KR)

(21) Appl. No.: 18/396,308

(22) Filed: Dec. 26, 2023

(30) Foreign Application Priority Data
Mar. 17, 2023 (CN) 202310265322.8

(51) Int. Cl. G06F 9/455

(52) U.S. Cl. CPC G06F 9/45558; G06F 9/45545; G06F 2009/45591

(57) ABSTRACT

The disclosure relates to a scheduling method, a virtual machine monitor, an electronic device and a storage medium. The scheduling method including obtaining running data of a guest operating system running on the virtual machine monitor and/or scheduling information of a first scheduler of the virtual machine monitor and adjusting a parameter of the first scheduler at least based on the obtained running data and/or adjusting a parameter of a second scheduler of the guest operating system at least based on the obtained scheduling information may be provided.

### CROSS-REFERENCE TO RELATED APPLICATIONS

This application claims priority under 35 U.S.C. § 119 to Chinese Patent Application No. 202310265322.8, filed on Mar. 17, 2023, in the State Intellectual Property Office (SIPO) of the People's Republic of China, the entire contents of which are incorporated herein by reference.

### BACKGROUND

### Technical Field

The disclosure generally relates to a field of a virtualization system, and in particular, to scheduling methods, virtual machine monitors, electronic devices and/or storage mediums.

### Description of Related Art

A virtualization system is a virtual machine system which is enabled to divide or arrange hardware resources of a single computer into multiple virtual computers (e.g., multiple virtual machines) and is mainly divided into two levels (e.g., a virtual machine monitor (Hypervisor) and a guest operating system (Guest OS). The virtual machine monitor (Hypervisor) runs between physical hardware and an operating system and allows multiple guest operating systems to share a set of physical hardware. The guest operating system (Guest OS runs on the virtual machine monitor.

Because the virtualization system is divided into two levels, CPU scheduling thereof is also divided into two kinds of scheduling performed by a scheduler inside the guest operating system and a scheduler at the VM monitor level. Accordingly, the CPU scheduling technology of the virtualization system mainly includes a physical CPU scheduling technology and a virtual CPU scheduling technology. The VM monitor (Hypervisor) schedules the virtual CPU on the physical CPU, and the Guest OS schedules system tasks on the CPU owned by the operating system. Because the two kinds of scheduling in the virtual machine system are located at different levels, they do not interfere with each other and do not contact each other, perform scheduling behaviors based on their own context, which leads to generation of a scheduling phenomenon, which is often called a double scheduling phenomenon. The double scheduling phenomenon results in problems such as locker holder preemption (LHP), inequitable virtual machine resource allocation, and/or unbalanced scheduling for a Simultaneous Multi-Processor (SMP), which lead to low overall scheduling performance of the virtual machine system (e.g., a computer).

### SUMMARY

According to an example embodiment of the present disclosure, a scheduling method performed by a virtual machine monitor may include obtaining running data of a guest operating system running on the virtual machine monitor and/or scheduling information of a first scheduler of the virtual machine monitor, and adjusting a parameter of the first scheduler at least based on the obtained running data and/or adjusting a parameter of a second scheduler of the guest operating system at least based on the obtained scheduling information.

The obtaining the running data may include obtaining the running data by using a virtual machine introspection technology.

The obtaining the running data by using the virtual machine introspection technology may include obtaining a value of a first variable of the guest operating system by using the virtual machine introspection technology, the first variable being a variable determined from a mirror symbol table of the guest operating system that can be used to indicate a running state of the guest operating system and obtaining the running data based on the value of the first variable.

The first variable may include a parameter related to the second scheduler, a parameter related to a task run by the guest operating system and/or a parameter related to CPU usage and the running data may include information related to the second scheduler, CPU usage of the guest operating system, and/or task execution of the guest operating system.

The adjusting the parameter of the second scheduler of the guest operating system at least based on the obtained scheduling information may include determining an adjustment value of a second variable through the scheduling information, the second variable being a variable related to the parameter of the second scheduler determined based on a mirror symbol table of the guest operating system and determining the adjustment value as a current value of the second variable by using a virtual machine introspection technology.

The second variable may include CPU capacity, CPU group capacity, and/or a load balancing interval.

According to an example embodiment of the present disclosure, a virtual machine monitor may include at least one processor configured to obtain running data of a guest operating system running on the virtual machine monitor and/or scheduling information of a first scheduler of the virtual machine monitor, and adjust a parameter of the first scheduler at least based on the obtained running data and/or adjust a parameter of a second scheduler of the guest operating system at least based on the obtained scheduling information.

The at least one processor may be configured to obtain the running data by using a virtual machine introspection technology.

The at least one processor may be configured to obtain the running data by using the virtual machine introspection technology by obtaining a value of a first variable of the guest operating system by using the virtual machine introspection technology, the first variable being a variable determined from a mirror symbol table of the guest operating system that can be used to indicate a running state of the guest operating system and obtaining the running data based on the value of the first variable.

The first variable may include a parameter related to the second scheduler, a parameter related to a task run by the guest operating system and/or a parameter related to CPU usage and the running data may include information related to the second scheduler, CPU usage of the guest operating system, and/or task execution of the guest operating system.

The at least one processor may be configured to adjust the parameter of the second scheduler of the guest operating system at least based on the obtained scheduling information by determining an adjustment value of a second variable through the scheduling information, the second variable being a variable related to the parameter of the second scheduler determined based on a mirror symbol table of the guest operating system and determining the adjustment value as a current value of the second variable by using a virtual machine introspection technology.

The second variable may include CPU capacity, CPU group capacity, and/or a load balancing interval.

According to an example embodiment of the present disclosure, an electronic device includes at least one memory storing computer-executable instructions, at least one processor configured to execute the computer-executable instructions to perform the above scheduling method.

According to an example embodiment of the present disclosure, there is provided a computer-readable storage medium having stored thereon instructions which, when executed by at least one processor, cause the at least one processor to perform the above scheduling method.

According to the scheduling method and the virtual machine monitor of the example embodiments of the disclosure, by obtaining running data of the guest operating system running on a virtual machine monitor and/or scheduling information of the first scheduler of the virtual machine monitor and adjusting a parameter of the first scheduler at least based on the obtained running data and/or a parameter of the second scheduler of the guest operating system at least based on the obtained scheduling information, cooperative scheduling may be effectively realized, thereby improving the overall scheduling performance of a system (e.g., a computer).

### BRIEF DESCRIPTION OF THE DRAWINGS

A more complete understanding of the disclosure and many accompanying aspects thereof may be easily obtained when the following detailed description is considered in conjunction with the accompanying drawings.

FIG. 1 is a schematic diagram illustrating two levels of scheduling for a virtual machine system;

FIG. 2 is a schematic diagram illustrating a locker holder preemption (LHP) problem that may result from a double scheduling phenomenon;

FIG. 3 is a schematic diagram illustrating a phenomenon of inequitable virtual machine resource allocation that may be caused by a double scheduling phenomenon;

FIG. 4 is a schematic diagram illustrating a phenomenon of unbalanced scheduling for a Simultaneous Multi-Processor (SMP) that may be caused by a double scheduling phenomenon;

FIG. 5 shows an example architecture, according to an example embodiment of the disclosure;

FIG. 6 illustrates a flowchart of a scheduling method performed by a virtual machine monitor, according to an example embodiment of the disclosure;

FIG. 7 is an example flowchart illustrating a scheduling method performed by the virtual machine monitor shown in FIG. 5, according to an example embodiment of the disclosure;

FIG. 8 is a block diagram illustrating a virtual machine monitor, according to an example embodiment of the disclosure; and

FIG. 9 is a block diagram illustrating an electronic device, according to an example embodiment of the disclosure.

### DETAILED DESCRIPTION

Specific terms have been used for clarity in describing some example embodiments of the disclosure shown in the drawings. However, the disclosure is not intended to be limited to the specific terms so chosen, and it should be understood that each particular element includes all technical equivalents that operate in a similar manner. It should be noted that the terms “first”, “second” and the like in the description and claims of the disclosure and the above drawings are used to distinguish similar objects, and are not necessarily used to describe a specific order or sequence. It is to be understood that the data used in this way may be interchanged under appropriate circumstances so that the example embodiments of the disclosure described herein can be practiced in orders other than those illustrated or described herein.

It should be noted herein that “at least one of several items” in the present disclosure means including three parallel situations of “any one of the several items”, “a combination of any of the several items”, “the whole of the several items”. For example, “including at least one of A and B” includes the following three parallel situations: (1) including A; (2) including B; (3) including A and B. Another example is “executing at least one of step 1 and step 2”, which means the following three parallel situations: (1) executing step 1; (2) executing step 2; (3) executing step 1 and step 2.

As used herein, expressions such as “at least one of,” when preceding a list of elements, modify the entire list of elements and do not modify the individual elements of the list. Thus, for example, both “at least one of A, B, or C” and “at least one of A, B, and C” mean either A, B, C or any combination thereof. The expression “A, B, and/or C” also mean either A, B, C or any combination thereof.

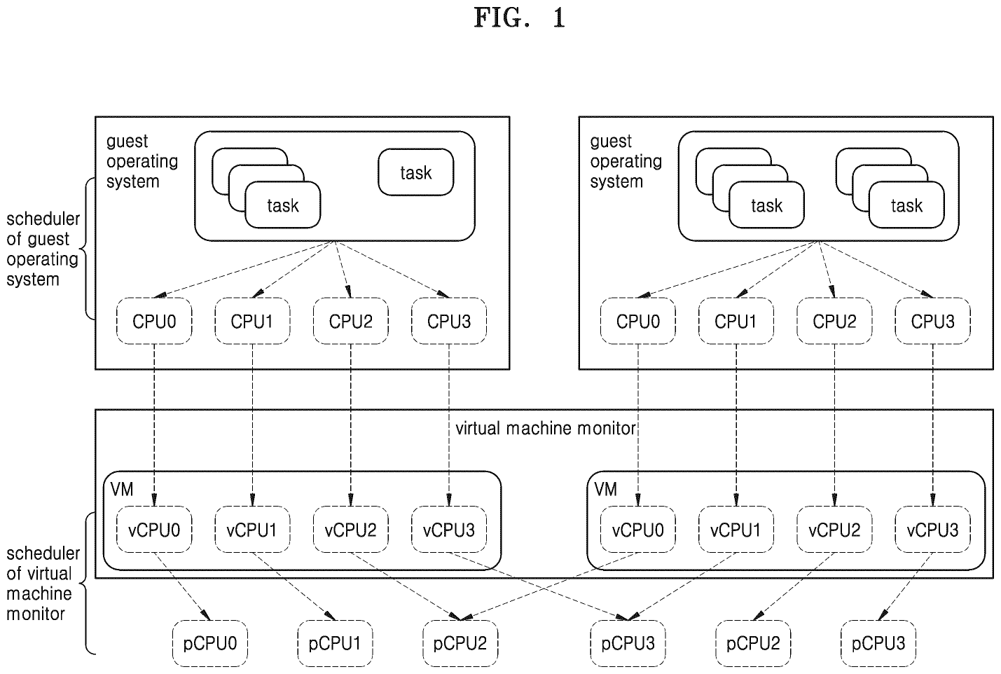

FIG. 1 is a schematic diagram illustrating two levels of scheduling for a virtual machine system.

As mentioned in the background and as shown in FIG. 1, a virtualization system is mainly divided into two levels (e.g., a virtual machine monitor (Hypervisor) and a guest operating system (Guest OS)). The virtual machine monitor runs between physical hardware and an operating system, and allows multiple guest operating systems to share a set of physical hardware. The guest operating system runs on the virtual machine monitor. For example, the virtual machine monitor may manage multiple virtual machines (VMs), each of which may run a guest operating system. A scheduler of the guest operating system schedules tasks in the system to run on virtual CPU (vCPU) resources, and a scheduler of the virtual machine monitor schedules a virtual CPU (vCPU) to run on CPU resources. These two schedulers schedule in their respective environments, wherein scheduling objects are different, scheduling methods are different, and scheduling algorithms are different.

Because the two scheduling methods of the virtual machine system do not interfere with each other and do not contact each other, they each schedule based on their own context, resulting in a double scheduling phenomenon. As mentioned in the background art, the double scheduling phenomenon may cause the problems such as locker holder preemption (LHP), inequitable virtual machine resource allocation, and unbalanced scheduling for a Simultaneous Multi-Processor (SMP), resulting in low overall scheduling performance of the virtual machine system (e.g., a computer).

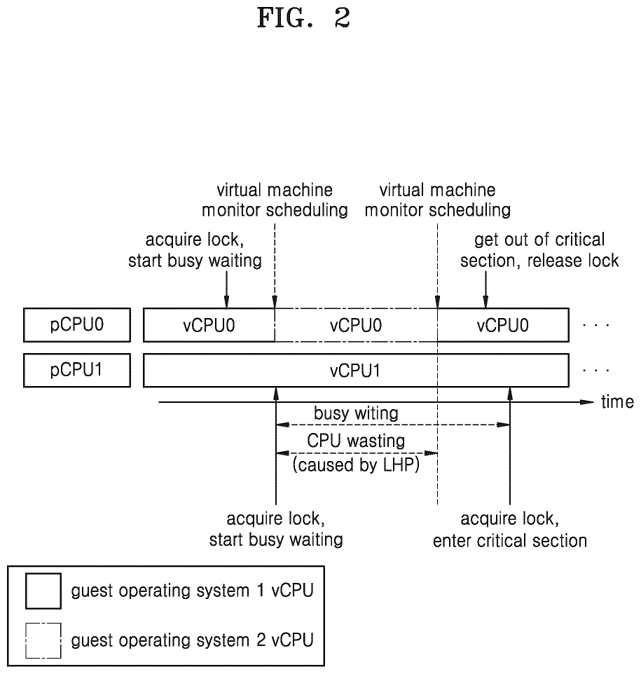

FIG. 2 is a schematic diagram illustrating a LHP problem that may result from a double scheduling phenomenon.

LHP usually means that a lock holder is deprived of a right to run by a virtual machine monitor, causing other threads waiting for the lock resources to keep spinning on a virtual CPU where they are located, thereby wasting CPU resources. As shown in FIG. 2, after a user Guest OS1 on a vCPU0 requests a lock, the vCPU0 is scheduled by a scheduler of the VM monitor to a Guest OS2. However, at this point, if a user on a vCPU1 (such as Guest OS1) requests a lock, only after vCPU0 is scheduled back to execute and release the lock, the user may apply for the use of the lock, the waiting time therebetween is useless waiting time caused by LHP.

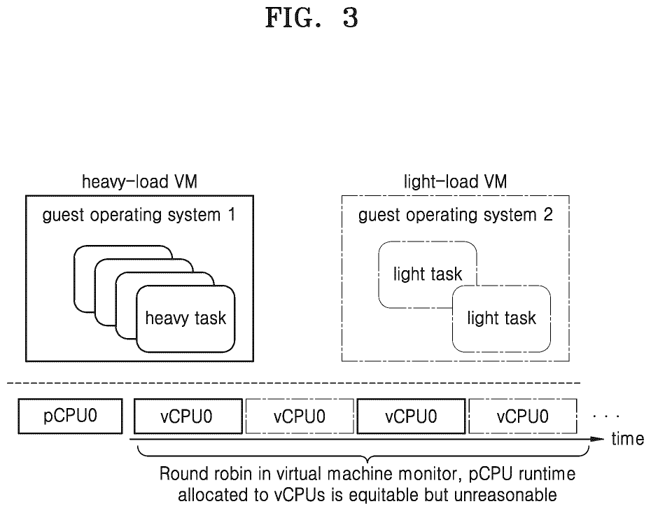

FIG. 3 is a schematic diagram illustrating a phenomenon of inequitable virtual machine resource allocation that may be caused by a double scheduling phenomenon.

A scheduler of a virtual machine monitor always schedules CPU resources according to its own algorithm, regardless of a state of a guest operating system of a virtual machine running on the virtual machine monitor. As shown in FIG. 3, a guest operating system 1 runs relatively heavy tasks, while a guest operating system 2 runs relatively light tasks. These two working states may use different CPU resources. However, the scheduler of the virtual machine monitor still allocates equal physical CPU (pCPU) runtime to vCPUs of the two guest operating systems with a round robin algorithm. This results in the fact that the guest operating system 1 with heavy tasks lacks sufficient CPU resources to process its tasks while the guest operating system 2 with light tasks wastes some CPU resources, which brings the problem of unreasonable resource allocation.

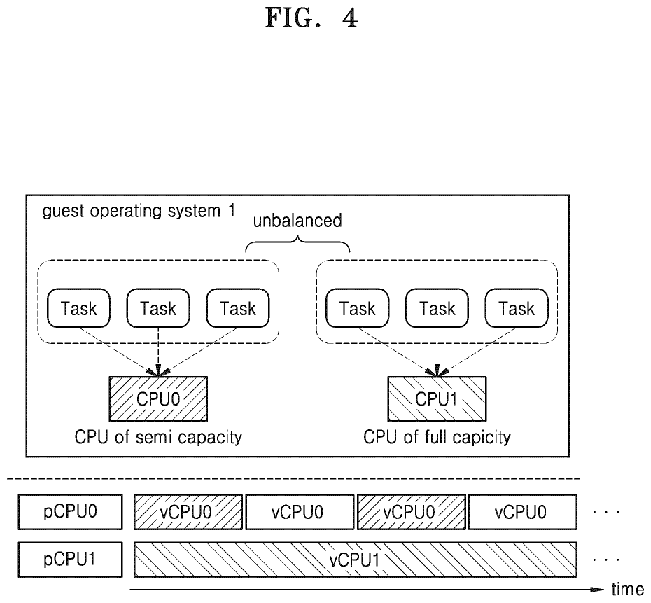

FIG. 4 is a schematic diagram illustrating a phenomenon of unbalanced scheduling for a SMP that may be caused by a double scheduling phenomenon.

From the perspective of a guest operating system, it always considers that it is exclusive to current CPU resources. In a case of sharing a CPU (e.g., a VM shares the CPU with other VMs), a phenomenon of unbalanced scheduling as shown in FIG. 4 may occur. As shown in FIG. 4, a scheduler of a guest operating system 1 considers CPU0 and CPU1 it owns have the same capacity, and assigns tasks to both CPUs equally. In fact, the guest operating system 1 shares CPU0 with another guest operating system, and CPU1 is completely scheduled by the guest operating system. That is, the capacities of CPU0 and CPU1 with respect to the guest operating system 1 are inconsistent, and this leads to task scheduling made by the scheduler of the guest operating system to be unreasonable or unbalanced.

The above problems may occur because the scheduler of the virtual machine monitor and the scheduler of the guest operating system are completely separated. There is no data communication between the scheduler of the virtual machine monitor and the scheduler of the guest operating system and the scheduler of the virtual machine monitor and the scheduler of the guest operating system do not know each other's scheduling state and scheduling method. Thus, the overall scheduling performance of the virtual machine system (e.g., a computer) may be deteriorated.

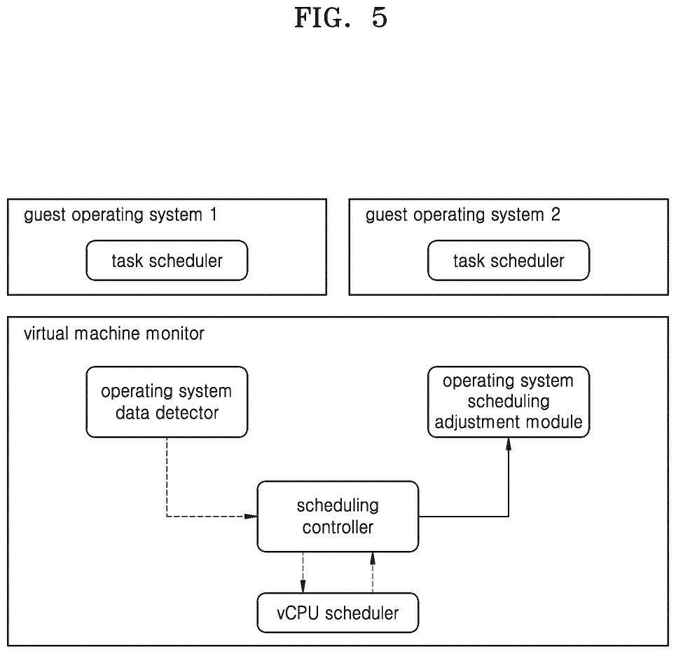

Some example embodiments of the disclosure propose a scheduling method that enables collaborative scheduling without making any changes to the guest operating system, but making some changes only to the virtual machine monitor. Below, some example embodiments of the disclosure are described with reference to FIGS. 5 to 9.

FIG. 5 shows an example architecture according to an example embodiment of the disclosure. As shown in FIG. 5, all modifications are centralized in a virtual machine monitor and no modification is made to a guest operating system. For example, the following three modules may be added to the virtual machine monitor:

### 1. An Operating System Data Detector

This module may monitor data from the guest operating system that is running by using a Vendor-Managed Inventory (VMI) technology. As an example, the data may mainly include information about a scheduler of an operating system (e.g., a scheduling period and a load balancing parameter), CPU usage (e.g., CPU usage rate), and/or execution of a current task.

### 2. An Operating System Scheduling Adjustment Module

This module determines variables related to parameters of a scheduler of the guest operating system by using the VMI technology, and dynamically adjusts values of the variables related to the parameters of the scheduler of the guest operating system in the virtual machine monitor according to information provided by a scheduling controller module (scheduling information of a scheduler of the virtual machine monitor), thereby realizing the adjustment of the parameters of the scheduler of the guest operating system.

### 3. A Scheduling Controller

This module acts as a bridge module between the scheduler of the guest operating system (also known as a “task scheduler”) and the scheduler of the virtual machine monitor (also known as a “vCPU scheduler”). The main functions of this module (e.g., a scheduling controller) include:
1) collecting running data of the guest operating system from the operating system data detector module (e.g., information related to the scheduler of the guest operating system, task execution of the guest operating system, and/or CPU usage), and adjusting parameters of the scheduler of the virtual machine monitor based on the running data.
2) monitoring a scheduling decision (deciding what kind of scheduling to execute), a scheduling behavior (what kind of scheduling operations is actually executed) and/or a scheduling state of the scheduler of the virtual machine monitor, and transferring the scheduling information of the scheduler of the virtual machine monitor to the operating system scheduling adjustment module.

It should be noted that the modifications to the virtual machine monitor are not limited to the above examples, that is, the virtual machine monitor does not necessarily have to include the above modules individually, the above modules may be merged or combined as long as the virtual machine monitor may perform a scheduling method described below. For example, if only the parameters of the scheduler of the virtual machine monitor are adjusted, the virtual machine monitor may not include the operating system scheduling adjustment module, and if only the parameters of the scheduler of the guest operating system are adjusted, it may not include the operating system data detector, or may include the operating system data detector, this is because the virtual machine monitor may adjust the parameters of the scheduler of the guest operating system at least based on the scheduling information of the scheduler of the virtual machine monitor. For example, the parameters of the scheduler of the guest operating system may be adjusted based only on the scheduling information of the scheduler of the virtual machine monitor (in this case, the virtual machine monitor may not contain the operating system data detector), or the parameters of the scheduler of the guest operating system may also be adjusted based on both the scheduling information of the scheduler of the virtual machine monitor and the running data of the guest operating system (in this case, the virtual machine monitor may include the operating system data detector).

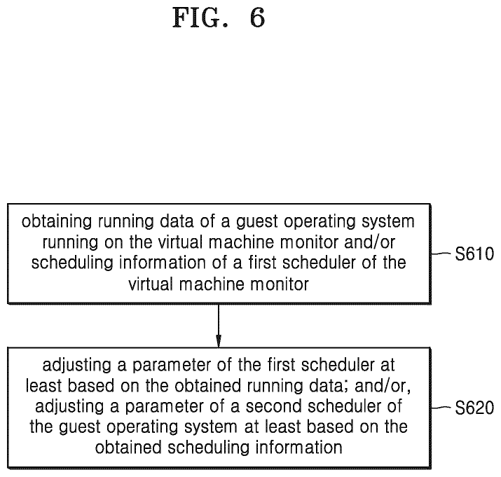

FIG. 6 illustrates a flowchart of a scheduling method performed by a virtual machine monitor according to an example embodiment of the disclosure. Referring to FIG. 6, in step S610, running data of a guest operating system running on the virtual machine monitor and/or scheduling information of a first scheduler of the virtual machine monitor is obtained. Subsequently, in step S620, a parameter of the first scheduler is adjusted at least based on the obtained running data, and/or a parameter of a second scheduler of the guest operating system is adjusted at least based on the obtained scheduling information. The guest operating systems may be, for example, a Linux operating system, an Android operating system, etc.

Below, the steps shown in FIG. 6 are described in detail with examples.

According to some example embodiments, in step S610, the obtaining the running data may include obtaining the running data by using a virtual machine introspection technology. For example, a method of monitoring a running state of a virtual machine from outside the virtual machine is called as VMI. VMI allows the virtual machine monitor to obtain the running data of the guest operating system without modifying the code of the guest operating system.

As an example, the running data includes information related to the second scheduler, CPU usage of the guest operating system, and/or task execution of the guest operating system. For example, the information related to the second scheduler may include a scheduling period of the second scheduler, a load balancing parameter (e.g., a load balancing interval), and so on.

For example, the CPU usage of the guest operating system may include CPU usage rate, etc. For example, the task execution of the guest operating system may include execution status of a current task of the guest operating system, etc. However, the above running data is not limited to the above examples, but may be a variety of data when the guest operating system is running.

For example, the obtaining the running data by using the virtual machine introspection technology may include (1) obtaining a value of a first variable of the guest operating system by using the virtual machine introspection technology, wherein the first variable is a variable determined from a mirror symbol table of the guest operating system that can be used to indicate a running state of the guest operating system and (2) obtaining the running data based on the value of the first variable. For example, the virtual machine introspection technology may be used to determine the first variable by analyzing mirror symbols of the guest operating system without modifying the code of the guest operating system. After the value of the first variable is obtained, for example, the value of the first variable may be directly taken as the running data, or values of various first variables may be statistically analyzed or various operational processing may be performed on the values, and the results of statistical analysis or operational processing may be taken as the running data. In some example embodiments, the value of the first variable may be further obtained based on a synthetic analysis and processing with other data affecting the operation of the guest operating system to determine the running data. However, the specific way of obtaining the running data based on the value of the first variable is not limited to the above example, and the method of obtaining the running data based on the value of the first variable is unlimited.

The above first variable may include, but is not limited to, a variable related to the second scheduler, a variable related to a task performed by the guest operating system and/or a variable related to CPU usage. The variable related to the second scheduler may be, for example, a scheduling period and/or a load balancing interval. The variable related to the task performed by the guest operating system may, for example, be a variable that reflects the execution of the current task. The variable related to CPU usage may be, for example, CPU usage rate.

For example, during an initialization stage of the virtual machine system, the operating system data detector module shown in FIG. 5 may determine the first variable by analyzing mirror symbol tables of multiple guest operating systems running on the virtual machine monitor using the VMI technology in advance. The mirror symbol table contains variables and corresponding addresses of various functions involved in the code of the guest operating system, and these variables include the first variable related to the state of the guest operating system. Subsequently, in a system running stage, for example, the operating system data detector module may periodically read the value of the first variable according to the obtained address of the first variable by the VMI technology (e.g., the setting of the period value should be appropriate to effectively obtain the system state change without increasing the system burden), and obtain the above running data based on the obtained value of the first variable.

In the case of obtaining the above running data in step S610, in step S620, the parameter of the first scheduler may be adjusted at least based on the obtained running data. For example, the parameter of the first scheduler may be adjusted based only on the obtained running data, or the parameter of the first scheduler may be adjusted based on both the obtained running data and the scheduling information related to the first scheduler. Because the running data of the guest operating system is taken into account when adjusting the parameter of the first scheduler of the virtual machine monitor, the first scheduler may better schedule resources and avoid the double scheduling phenomenon as much as possible. For example, during the system running stage, the operating system data detector module may periodically send the running data to the scheduling controller module. The scheduling controller module may analyze the above running data and dynamically adjust the parameter of the first scheduler of the virtual machine monitor according to the analysis results. For example, these parameters may include, but are not limited to, a time slice of the CPU allocated to the guest operating system and a number of CPUs allocated to the guest operating system.

For example, it is assumed that two guest operating systems A and B are currently running on the virtual machine monitor, and A and B share a CPU, and time slice allocation of the shared CPU is controlled by the first scheduler of the virtual machine monitor. At a certain point in time, it is assumed that the VM monitor obtains from the operating system data detector module that the task loads (a kind of the running data) of A and B are different, for example, A is running heavy-load tasks and B is running light-load tasks. In this case, for example, the operating system data detector module may transfer the information to the scheduling controller module, the scheduling controller module then adjusts the parameter regarding sharing the CPU time slice of the first scheduler of the virtual machine monitor accordingly, lengthens the time slice of the CPU allocated to A for running and shortens the time slice of the CPU allocated to B for running, thereby making A obtain more CPU resources and ensuring the running of the heavy-load tasks on A.

For example, it is assumed that two guest operating systems A and B are currently running on the virtual machine monitor, the VM monitor obtains from the operating system data detector module that the CPU usage rate of the guest operating system A is relatively high while that of the guest operating system B is relatively low. In this case, the scheduling controller module may adjust the number of CPUs allocated to the guest operating systems. The number of CPUs allocated to the guest operating system A increases while the number of CPUs allocated to the guest operating system B decreases. In some example embodiments, if the guest operating systems A and B share a CPU, the time slice of the CPU allocated to A for running may be lengthened and the time slice of the CPU allocated to B for running may be shortened, thereby making A obtain more CPU resources.

For example, it is assumed that two guest operating systems A and B are currently running on the virtual machine monitor, and the guest operating systems A and B share a CPU, the VM monitor obtains from the operating system data detector module that the load balancing interval of the guest operating system A becomes shorter, then the response to the guest operating system A needs to be faster. In this case, the scheduling controller module may adjust the number of CPUs allocated to the guest operating system or the time slice of the CPU allocated to the guest operating system, or even make the shared CPU exclusive to the guest operating system.

In some example embodiments, although not shown in FIG. 6, the method shown in FIG. 6 may also include performing CPU resource scheduling based on the adjusted parameter of the first scheduler after the parameter of the first scheduler has been adjusted.

The above describes that the virtual machine monitor may adjust the parameter of its own first scheduler based on the running data of the guest operating system. Based on the scheduling method shown in FIG. 6, the virtual machine monitor may also adjust a parameter of a second scheduler of the guest operating system based on scheduling information related to the first scheduler of the virtual machine monitor. This is described below with some examples.

As shown in FIG. 6, the scheduling information for the first scheduler of the virtual machine monitor may be acquired in step S610. As an example, the scheduling information of the first scheduler may be scheduling decision information of the first scheduler, for example, a decision made by the first scheduler to allocate CPU resources allocated to one guest operating system to another guest operating system in a way of time slice cycling, or a scheduling period of the first scheduler. For example, a scheduling behavior of the first scheduler may be monitored and the scheduling information may be obtained based on the scheduling behavior. For example, the scheduling controller in the virtual machine monitor may monitor the scheduling behavior of the first scheduler to collect the scheduling information (e.g., the scheduling decision information) of the first scheduler during the system running stage. The collected information may be sent to the operating system scheduling adjustment module.

Subsequently, in step S620, the parameter of the second scheduler of the guest operating system may be adjusted at least based on the obtained scheduling information. For example, the parameter of the second scheduler may be adjusted based only on the obtained scheduling information of the first scheduler, or the parameter of the second scheduler may be adjusted based on both the obtained scheduling information of the first scheduler and the running data of the guest operating system. Because the scheduling information of the first scheduler of the virtual machine monitor is considered in adjusting the parameter of the second scheduler of the guest operating system, the second scheduler of the guest operating system may more reasonably schedule resources based on these adjusted parameters, so as to avoid or mitigate the occurrence of the double scheduling phenomenon.

For example, an adjustment value of a second variable may be determined through the scheduling information of the first scheduler, and the adjustment value may be determined as a current value of the second variable by using the virtual machine introspection technology. Here, the second variable is a variable related to the parameter of the second scheduler determined based on a mirror symbol table of the guest operating system. For example, the second variable may be determined by analyzing mirror symbols of the guest operating system. The adjustment value may then be determined as the current value of the second variable using the virtual machine introspection technology. Through the virtual machine introspection technology, the current value of the second variable may be modified without modifying the code of the guest operating system.

As an example, the above second variable may include, but is not limited to, CPU capacity, CPU group capacity and/or a load balancing interval. The CPU capacity may represent how many bits of information a CPU may execute in one period. The CPU group capacity refers to how many bits of information a CPU group may execute in one period in a scenario where CPUs are scheduled by group. The load balancing interval may indicate how often a load balancing operation is performed.

For example, during the system initialization stage, the operating system scheduling adjustment module in the virtual machine monitor may analyze the mirror symbol table of the guest operating system through the VMI technology, determine the variables related to the parameter of the second scheduler of the guest operating system (e.g., the above second variables) and obtain addresses of these variables.

In the system running stage, the operating system scheduling adjustment module in the virtual machine monitor may receive the scheduling information of the first scheduler from the scheduling controller and analyze the scheduling information. Based on the analysis results, the adjustment value of the scheduling parameter of the second scheduler of the guest operating system may be obtained. The adjustment value is dynamically written to the address of the second variable of the guest operating system by using the VMI technology, so that the parameter of the second scheduler of the guest operating system may be changed directly in the virtual machine monitor. For example, the VMI technology may be used to modify the operating environment of the code of the guest operating system so that the virtual machine monitor may assign a new value to the second variable under the modified operating environment. However, the method of using the VMI technology to determine the adjustment value as the current value of the second variable is not limited to the foregoing. The value of the second variable may be modified using the VMI technology in different ways depending on the CPU hardware.

As an example, assume that the current VM system runs two guest operating systems, A and B, and the VM system has four CPU cores. CPU0 is allocated to A independently, CPU3 is allocated to B independently, and CPU1 and CPU2 are shared to A and B in a way of cycling a time slice. At a certain point in time, the scheduling controller of the virtual machine monitor collects a piece of scheduling information from the first scheduler of the virtual machine monitor that the first scheduler is to perform time slice cycling to allocate CPU1 and CPU2 resources allocated to the guest operating system A to the guest operating system B. The scheduling controller module may transmit this information to the operating system scheduling adjustment module. After analyzing this information, the operating system scheduling adjustment module makes a decision to adjust a CPU capacity parameter of the guest operating system A. Then the operating system scheduling adjustment module may modify the CPU capacity parameter of A to a new value through the VMI technology. The scheduler of A may then perform its own scheduling activity based on this new value. This scheduling activity may be referred to as a load balancing scheduling activity).

It should be noted that step 620 may only “adjust the parameter of the first scheduler at least based on the obtained running data” (hereinafter referred to as “operation 1”) or only “adjust the parameter of the second scheduler of the guest operating system at least based on the obtained scheduling information” (hereinafter referred to as “operation 2”), or perform the operation 1 and the operation 2, which depends on the information obtained in step S610. If step S610 has obtained the running data of the guest operating system, the operation 1 may be performed. If step S610 has obtained the scheduling information of the first scheduler, the operation 2 may be performed. If the running data of both of the guest operating system and the scheduling information of the first scheduler are obtained, the operations 1 and 2 may be performed. In addition, when both the operation 1 and the operation 2 are performed, the execution sequence of the operation 1 and the operation 2 is not limited, and the operation 1 may be performed before the operation 2, or the operation 1 may be performed after the operation 2, or the operation 1 and the operation 2 may be performed at the same time, and the operation 1 and the operation 2 may not affect each other.

Above, the scheduling method executed by the virtual machine monitor according to the embodiment has been described with reference to FIG. 6. According to this scheduling method, because the running data of the guest operating system is considered in adjusting the parameter of the first scheduler of the virtual machine monitor, it may facilitate the first scheduler to schedule resources more reasonably, thus avoiding the occurrence of the double scheduling phenomenon as much as possible. In addition, because the scheduling information of the first scheduler of the virtual machine monitor is considered in adjusting the parameter of the second scheduler of the guest operating system, it may facilitate the second scheduler of the guest operating system to schedule resources more reasonably based on these adjusted parameters, so as to avoid or mitigate the occurrence of the double scheduling phenomenon as much as possible. In other words, according to the above scheduling method, collaborative scheduling may be realized and the overall scheduling performance of the virtual machine system (e.g., a computer) may be improved. In addition, according to the above scheduling method, collaborative scheduling may be achieved without modifying the guest operating system, and the above scheduling method does not need the deep communication between the virtual machine scheduler and the guest operating system to achieve the collaborative scheduling. Therefore, the difficulty and cost of development may be greatly reduced, and the adaptability with the guest operating system can be increased.

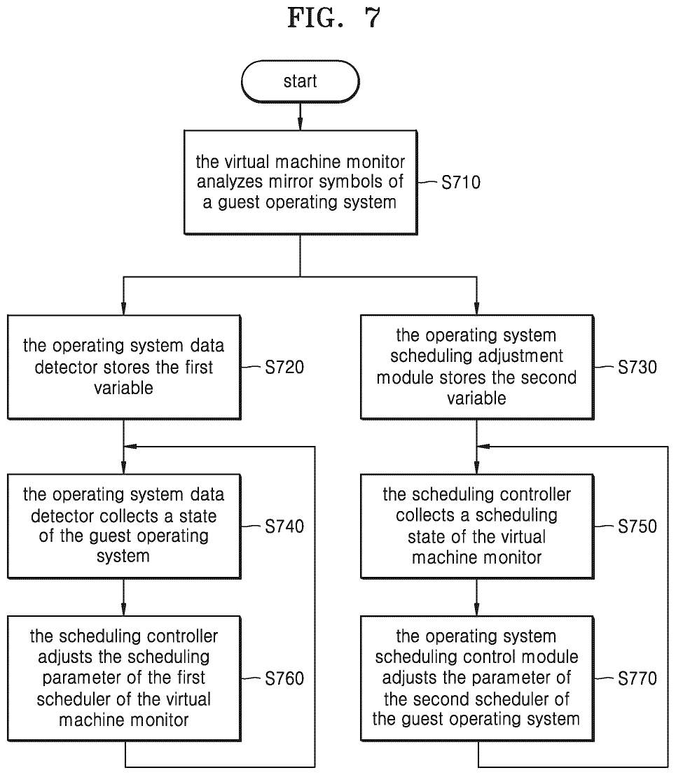

For ease of understanding, the above scheduling method is briefly described by referring to the example in FIG. 7. FIG. 7 is an example flowchart illustrating a scheduling method performed by the virtual machine monitor shown in FIG. 5 according to an example embodiment of the disclosure.

It is assumed that the virtual machine monitor as shown in FIG. 5 includes an operating system data detector, an operating system scheduling adjustment module, and a scheduling controller. As shown in FIG. 7, in step S710, the virtual machine monitor analyzes mirror symbols of a guest operating system to determine a first variable indicating a running state of the guest operating system and a second variable related to a parameter of a second scheduler of the guest operating system. Next, in step S720, the operating system data detector may store the first variable. In step S730, the operating system scheduling adjustment module may store the second variable. In step S740, the operating system data detector may collect a state of the guest operating system to obtain running data of the guest operating system. For example, the running data of the guest operating system is obtained based on a value of the first variable that indicates the running state of the guest operating system. In step S750, the scheduling controller may collect a scheduling state of the virtual machine monitor to obtain scheduling information related to a first scheduler of the virtual machine monitor. In step S760, the scheduling controller may adjust the scheduling parameter of the first scheduler of the virtual machine monitor based on the obtained running data. In step S770, the operating system scheduling control module may adjust the parameter of the second scheduler of the guest operating system based on the obtained scheduling information. Steps S740 and S760 may be repeated periodically, and steps S750 and S770 may be repeated periodically, to periodically adjust the parameter of the second scheduler of the guest operating system based on the scheduling information related to the first scheduler of the virtual machine monitor, and periodically adjust the parameter of the first scheduler of the virtual machine monitor based on the running data of the guest operating system, thereby avoiding or mitigating the double scheduling phenomenon as much as possible.

Scheduling methods according to some example embodiments of the disclosure have been described above in conjunction with FIGS. 5 to 7. The above scheduling method may be applied to any computer system using the virtualization technology, for example, a vehicle-machine system using the virtualization technology, such as a vehicle-machine system used in the field of autonomous driving. By using the scheduling method according to some example embodiments of the disclosure, because no modification is made to the guest operating system, it may greatly reduce the difficulty of development and increase the adaptability with the guest operating system. After implementing such scheduling methods, the overall scheduling performance of the virtual machine system (e.g., a computer) may be improved.

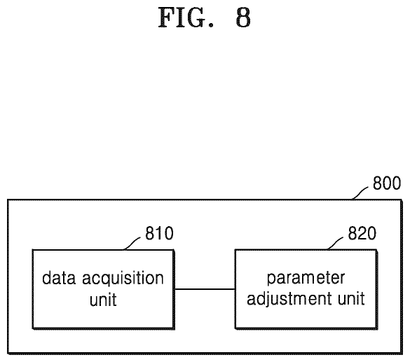

FIG. 8 is a block diagram illustrating a virtual machine monitor 800, according to an example embodiment of the disclosure.

With reference to FIG. 8, the VM monitor 800 may include a data acquisition unit 810 and a parameter adjustment unit 820. For example, the data acquisition unit 810 may be configured to obtain running data of a guest operating system running on the virtual machine monitor and/or scheduling information of a first scheduler of the virtual machine monitor. The parameter adjustment unit 820 may be configured to adjust a parameter of the first scheduler at least based on the obtained running data and/or adjust a parameter of a second scheduler of the guest operating system at least based on the obtained scheduling information. The details involved in the specific operations performed by the data acquisition unit 810 and the parameter adjustment unit 820 have been described above, so they will not be repeated here. The data acquisition unit 810 and the parameter adjustment unit 820 may represent functions performed by at least one processor included in the VM monitor 800.

According to some example embodiments of the disclosure, the data acquisition unit 810 may obtain a value of a first variable of the guest operating system by using a virtual machine introspection technology, and may obtain the running data based on the obtained value of the first variable. Here, the first variable may be a variable determined from a mirror symbol table of the guest operating system that may be used to indicate a running state of the guest operating system. By using the virtual machine introspection technology, the running data of the guest operating system may be obtained without modifying the code of the guest operating system. In addition, the adjustment unit 820 may determine an adjustment value of a second variable through the scheduling information and determine the adjustment value as a current value of the second variable by using the virtual machine introspection technology, thus realizing the adjustment of the parameter of the second scheduler of the guest operating system at least based on the obtained scheduling information. Here, the second variable may be a variable related to the parameter of the second scheduler determined based on the mirror symbol table of the guest operating system. By using the virtual machine introspection technology, the parameter of the second scheduler of the guest operating system may be adjusted without modifying the code of the guest operating system.

In addition, according to some example embodiments, the virtual machine monitor 800 may also include the first scheduler. The first scheduler may be configured to perform CPU resource scheduling based on the adjusted parameter of the first scheduler after the parameter of the first scheduler is adjusted.

Any relevant details about the operations performed by the units mentioned above may be found in the corresponding descriptions of FIGS. 5 to 7 provided above.

In addition, it should be noted that although the virtual machine monitor 800 is described above as being divided into units for performing the corresponding processing separately, it is clear to those skilled in the art that the processing performed by the above units may also be performed without any specific unit division of the virtual machine monitor 800 or with no clear demarcation between the units. In addition, the unit division of the virtual machine monitor 800 is not limited to the example in FIG. 8. For example, virtual machine monitor may include units as shown in FIG. 5. The disclosure does not place any restrictions on how the virtual machine monitor 800 may be divided into units or modules, as long as it can perform the scheduling method shown in FIG. 6. In addition, the VM monitor 800 may also include other units, such as a storage unit.

It should also be understood that various units may be realized as one or more electronic circuits, and that one or more of these various units may also be realized as a single electronic circuit.

According to the virtual machine monitor of some example embodiments of the disclosure, by obtaining the running data of the guest operating system running on the virtual machine monitor and/or the scheduling information of the first scheduler of the virtual machine monitor and adjusting the parameter of the first scheduler at least based on the obtained running data and/or adjusting the parameter of the second scheduler of the guest operating system at least based on the obtained scheduling information, cooperative scheduling may be effectively realized, thus improving the overall scheduling performance of the virtual machine system (e.g., a computer).

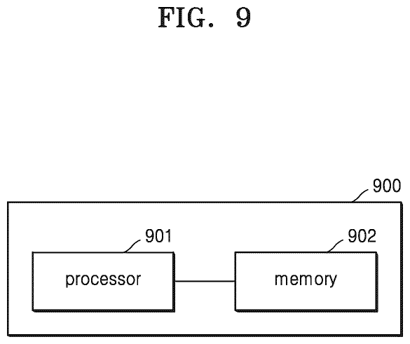

FIG. 9 is a block diagram illustrating an electronic device according to an example embodiment of the disclosure.

Referring to FIG. 9, the electronic device 900 may include at least one memory 901 and at least one processor 902. The at least one memory 901 stores computer executable instructions which, when executed by the at least one processor 902, cause the at least one processor 902 to execute the scheduling method according to some example embodiments of the disclosure.

As an example, the electronic device 900 may be a PC computer, a tablet device, a personal digital assistant, a smartphone, or any other device capable of executing the above set of instructions. The electronic device 900 may be connected to a wireless LAN. Here, the electronic device 900 does not have to be a single electronic device, but a collection of devices or circuits capable of executing the instructions (or instruction set) individually or jointly. The electronic device may also be part of an integrated control system or system manager, or may be configured as a portable electronic device that interfaces locally or remotely (e.g., via wireless transmission).

In the electronic device 900, the processor 902 may include a central processing unit (CPU), graphics processor (GPU), programmable logic device, dedicated processor system, microcontroller, or microprocessor. As an example, the processor may also include analog processors, digital processors, microprocessors, multi-core processors, processor arrays, network processors, and so on.

The processor 902 may run instructions or code stored in the memory 901, where the memory 901 may also store data. The instructions and data may also be sent and received over a network via a network interface device, which may use any known transmission protocol.

The memory 901 may be integrated with the processor 902. For example, the memory 901 may be RAM or flash memory arranged in an integrated circuit microprocessor. In addition, the memory 901 may include independent devices such as external disk drives, storage arrays, or other storage devices available to any database system. The memory 901 and the processor 902 may be coupled operationally, or may communicate with each other, through, for example, I/O ports or network connections such that the processor 902 can read files stored in the memory 901.

In addition, the electronic device 900 may include video displays (e.g., liquid crystal displays) and user interaction interfaces (e.g., keyboards, mice, or touch input devices). All components of the electronic device may be connected to each other via a bus and/or a network.

According to some example embodiments of the present disclosure, a computer readable storage medium storing a computer program is also provided. The computer program, when executed by at least one processor, causes the at least one processor to perform a scheduling method according to some example embodiments of the present disclosure. Examples of computer-readable storage media herein include Read Only Memory (ROM), Random Access Programmable Read Only Memory (RAPROM), Electrically Erasable Programmable Read Only Memory (EEPROM), Random Access Memory (RAM), Dynamic Random Access Memory (DRAM), Static Random Access Memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blue-ray or optical disk storage, Hard Disk Drive (HDD), Solid State Drive (SSD), card storage (such as multimedia cards, secure digital (SD) cards or extremely fast digital (XD) cards), magnetic tapes, floppy disks, magneto-optical data storage devices, optical data storage devices, hard disks, solid state disks, and any other devices that are configured to store computer programs and any associated data, data files and data structures in a non-transitory manner and provide the computer programs and any associated data, data files and data structures to a processor or computer so that the processor or computer can execute the computer programs. The instructions or computer programs in the computer-readable storage medium described above may be executed in an environment deployed in a computer device. In addition, in one example, the computer programs and any associated data, data files, and data structures are distributed on a networked computer system, so that the computer programs and any associated data, data files, and data structures are stored, accessed and executed through one or more processors or computers in a distributed manner.

Any functional blocks shown in the figures and described above may be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

Those skilled in the field will understand that, without departing from the scope of the disclosure, the example embodiments of the disclosure may be modified based on what has been described. This application is intended to cover any variation, use or adaptation of the disclosure which is subject to the general principles of the disclosure.

What is claimed is:

1. A scheduling method performed by a virtual machine monitor, comprising:
obtaining running data of a guest operating system running on the virtual machine monitor and/or scheduling information of a first scheduler of the virtual machine monitor; and
adjusting a parameter of the first scheduler at least based on the obtained running data and/or adjusting a parameter of a second scheduler of the guest operating system at least based on the obtained scheduling information.

2. The scheduling method according to claim 1, wherein the obtaining comprises obtaining the running data by using a virtual machine introspection technology.

3. The scheduling method according to claim 2, wherein the obtaining the running data by using the virtual machine introspection technology comprises:
obtaining a value of a first variable of the guest operating system by using the virtual machine introspection technology, the first variable being a variable determined from a mirror symbol table of the guest operating system; and
obtaining the running data based on the value of the first variable.

4. The scheduling method according to claim 3, wherein
the first variable comprises a parameter related to the second scheduler, a parameter related to a task run by the guest operating system and/or a parameter related to CPU usage; and
the running data comprises information related to the second scheduler, CPU usage of the guest operating system, and/or task execution of the guest operating system.

5. The scheduling method according to claim 1, wherein the adjusting the parameter of the second scheduler of the guest operating system at least based on the obtained scheduling information comprises:
determining an adjustment value of a second variable through the scheduling information, the second variable being a variable related to the parameter of the second scheduler determined based on a mirror symbol table of the guest operating system; and
determining the adjustment value as a current value of the second variable by using a virtual machine introspection technology.

6. The scheduling method according to claim 5, wherein the second variable comprises CPU capacity, CPU group capacity, and/or a load balancing interval.

7. A virtual machine monitor, comprising:
at least one processor configured to,
obtain running data of a guest operating system running on the virtual machine monitor and/or scheduling information of a first scheduler of the virtual machine monitor, and
adjust a parameter of the first scheduler at least based on the obtained running data and/or adjusting a parameter of a second scheduler of the guest operating system at least based on the obtained scheduling information.

8. The virtual machine monitor according to claim 7, wherein the at least one processor is configured to obtain the running data by using a virtual machine introspection technology.

9. The virtual machine monitor according to claim 8, wherein the at least one processor is configured to obtain the running data by using the virtual machine introspection technology by:
obtaining a value of a first variable of the guest operating system by using the virtual machine introspection technology, the first variable being a variable determined from a mirror symbol table of the guest operating system; and
obtaining the running data based on the value of the first variable.

10. The virtual machine monitor according to claim 9, wherein
the first variable comprises a parameter related to the second scheduler, a parameter related to a task run by the guest operating system and/or a parameter related to CPU usage; and
the running data comprises information related to the second scheduler, CPU usage of the guest operating system, and/or task execution of the guest operating system.

11. The virtual machine monitor according to claim 7, wherein
the at least one processor is configured to adjust the parameter of the second scheduler of the guest operating system at least based on the obtained scheduling information by,
determining an adjustment value of a second variable through the scheduling information, the second variable being a variable related to the parameter of the second scheduler determined based on a mirror symbol table of the guest operating system, and
determining the adjustment value as a current value of the second variable by using a virtual machine introspection technology.

12. The virtual machine monitor according to claim 11, wherein the second variable comprises CPU capacity, CPU group capacity, and/or a load balancing interval.

13. A computer-readable storage medium having stored thereon instructions which, when executed by at least one processor, cause the at least one processor to perform the scheduling method according to claim 1.
